(19) United States
(12) Patent Application Publication
(10) Pub. No.: US 2026/0336504 A1
(43) Pub. Date: Oct. 29, 2026

(54) Drill Powered Load Binder

(71) Applicant: Durabilt Dyvex, Inc., Broadview, IL (US)

(72) Inventors: Thomas Durbin, Broadview, IL (US); Mark Grote, Oakbrook Terrace, IL (US); Sige Du, Chicago, IL (US)

(21) Appl. No.: 19/192,158

(22) Filed: Apr. 28, 2025

(51) Int. Cl. B60P 7/08

(52) U.S. Cl. CPC B60P 7/0838

(57) ABSTRACT

An improved drill powered load binder is suitable for restraining heavy loads and cargo. The disclosed device includes a hook at each end that is configured to couple with a secure location. The load binder device expands and contracts to decrease and increase tension between the two hooks, thus providing securing force for loads or cargo.

The present invention includes an outer housing that fits over an inner housing with a threaded lead screw with a hexagonal head is routed through the central cavity of the inner and outer housings. The threads of the lead screw couple with complimentary threads of the inner housing. Rotation of the lead screw causes the inner threads of the inner housing to move up and down the threaded lead screw thus making the two hooks either move closer to each other or farther apart depending on the direction of rotation thus increasing or decreasing tension between the two hooks. The hexagonal head of the lead screw is rotatable using a power operated drill.

### BACKGROUND OF THE INVENTION

### Field of the Invention

The present invention relates to binding devices that secure or hold down materials or loads during transit. Load binders are used to secure cargo while in transport in/on trucks, trains or ships. Typically, these load binders include two connecting ends, each that connect to a separate securing point and/or anchor point, with adjustable tension between the two securing points. Load binders well known in the art often require manual tightening. A common example of a manually operated load binders is a handle operated ratchet binder. The ratchet binder uses a gear mechanism manually powered by a lever to increase or decrease the distance between the two connecting ends. This manual operation requires human powered manual labor. Manual labor is costly in both time and human capital.

The present invention relates to an improved load binder which also includes two connecting ends. The connecting ends often include hooks, collared jaws or other connecting mechanisms. In the present invention, the tension between the two ends is adjustable using a power drill or other rotary tool. This improved drill powered load binder enables quicker and less laborious adjustment of load binders.

### Summary of the Invention

An improved drill powered load binder is disclosed. The improved drill powered load binder is suitable for restraining heavy loads and cargo. The disclosed device includes a hook at each end that is configured to couple with a secure location. The load binder device expands and contracts to decrease and increase tension between the two hooks, thus providing securing force for loads or cargo.

The present invention includes an outer housing that fits over an inner housing. A threaded lead screw with a hexagonal head is routed through the central cavity of the inner and outer housings. The threads of the lead screw couple with complimentary threads of the inner housing. A first hook is attached to the end of the outer housing and a second hook is attached to the end of the inner housing. Rotation of the lead screw causes the inner threads of the inner housing to move up and down the threaded lead screw thus making the two hooks either move closer to each other or farther apart depending on the direction of rotation. This movement has the effect of increasing or decreasing tension between the two hooks. The hexagonal head of the lead screw is rotatable using a power operated drill. This power operation provides quick adjustment that requires minimal human labor.

A first embodiment of the load binder includes a fixed eye attached to the inner housing. A second embodiment of the load binder includes a swivel eye attached to the inner housing using a ball joint. The swivel eye is rotatable and moveable in two lateral directions. Various other component parts make up the improved load binder and contribute to useful operation.

### BRIEF DESCRIPTION OF THE DRAWINGS

FIG. 1 is a perspective view of a first embodiment of the improved drill powered load binder.

FIG. 2 is a side view of a first embodiment of the improved drill powered load binder.

FIG. 3 is an exploded view of a first embodiment of the improved drill powered load binder.

FIG. 4 is detail view of the end of the lead screw, pin and oil nozzle of the improved drill powered load binder.

FIG. 5 is a detail view of the inner washer, pin and oil nozzle of the improved drill powered load binder.

FIG. 6 is a perspective view of a second embodiment of the improved drill powered load binder.

FIG. 7 is a side view of a second embodiment of the improved drill powered load binder.

FIG. 8 is an exploded view of a second embodiment of the improved drill powered load binder.

FIG. 9 is detail view of the end of the lead screw, pin and oil nozzle of the second embodiment of the improved drill powered load binder.

FIG. 10 is a detail view of the inner washer, pin and oil nozzle of the second embodiment of the improved drill powered load binder.

### DESCRIPTION OF THE PREFERRED EMBODIMENT

The following detailed description refers to the preferred embodiment of the disclosed invention as shown in the attached figures and in the below description. This detailed description is not meant to limit the scope of the invention in any way but is intended to disclose the preferred embodiment/best mode of the invention at the time of filing this application.

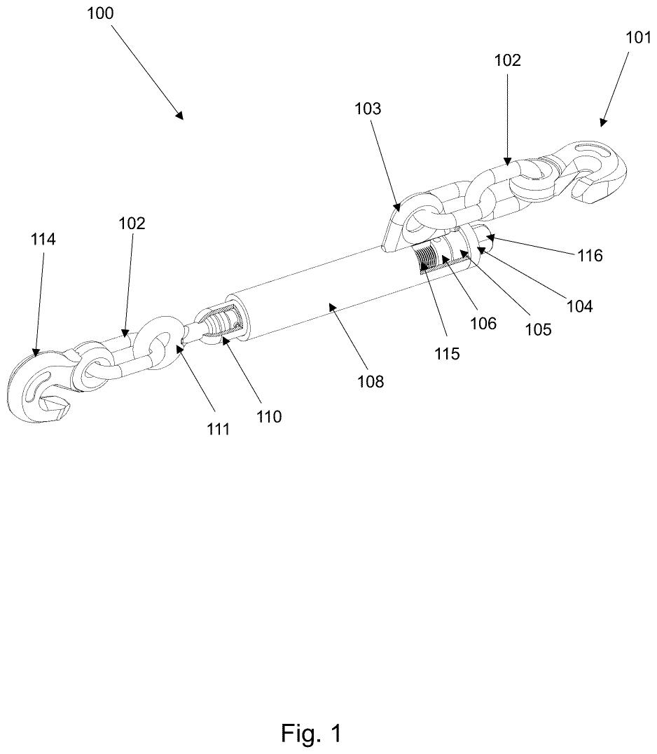

FIG. 1 is a perspective view of a first embodiment of the improved drill powered load binder 100 of the present invention. In this view, a first hook 101 is shown coupled to two link(s) 102 which are coupled to fixed ring 103. Any configuration of hooks, links, rings or clevis yokes could be used in place of fixed ring 103 to create an attachment point for load binder 100. First hook 101 may be utilized to couple one end of load binder 100 with a fixed point to secure a cargo or load. Links 102 provide flexible coupling to fixed ring 103 which is attached to outer housing 108 of load binder 100. Second hook 114 is coupled to another link 102 which is further coupled to fixed eye 111. Fixed eye 111 is coupled to inner housing 110 of load binder 100. Inner housing 110 has a threaded internal surface that couples with threads 115 of lead screw 104. Screw head 116 is a hexagonal shape in the preferred embodiment and is designed to couple with a complementary sized/shaped socket attached to a power drill (not shown). In the preferred embodiment, the shape of screw head 116 and complementary socket are hexagonal (six sided head), but any shape well known in the art may be used, such as square, eight point (eight sided), spline, 12 point, internal/external six point star shape (known as Torx®), internal hex, crowsfoot, other star configurations, or any other suitable shape.

In some embodiments of the present invention, link 102 may be a link that is welded closed. Other types of links 102 may be used, including those that may be connected and disconnected using removable pins or other means to open, close and secure link 102.

When screw head 116 is rotated in a first direction, the threads 115 on lead screw 104 are rotated in the threaded internal surface of inner housing 110. In the first direction, the rotation of the complementary threads draws inner housing 110 closer to fixed ring 103, which in turn draws fixed eye 111 closer to fixed ring 103. This results in first hook 101 being drawn closer to second hook 114, resulting in additional tension on load binder 100. This tension assists in securing cargo or loads held in place using load binder 100. Typically, the first direction is right or clockwise. When screw head 116 is rotated in a second direction (typically counter-clockwise or left), inner housing 110 is moves farther away from fixed ring 103 thus reducing tension on between the first hook 101 and second hook 114 of load binder 100.

In this improved drill load binder 100, the rotation of screw head 116 may be performed with a powered drill (electrical or pneumatic) which results in significantly faster operation requiring minimal human labor, in contrast to prior art type load binder designs that must be tightened manually using a handle.

In this embodiment, fixed eye 111 is welded to inner housing 110 and thus fixed in position. In a second embodiment, the eye includes a swivel joint that allows the eye to rotate and move to various angles.

Improved drill powered load binder 100 is further comprised of inner washer 105 and outer washer 106 which provide spacing and separation between inner housing 108, outer housing 110 and lead screw 104.

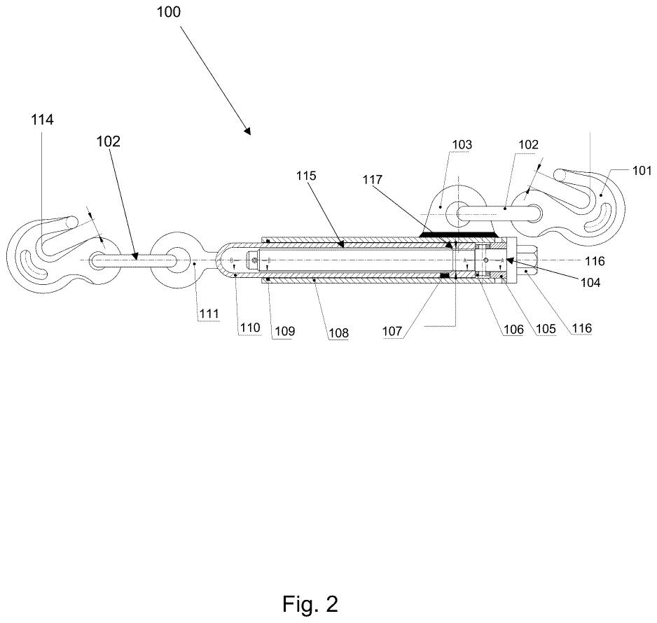

FIG. 2 displays a side view of improved drill powered load binder 100 of the present invention. First hook 101 is shown coupled to link 102 which is further coupled to fixed ring 103. Any configuration of hooks, links, rings or clevis yokes could be used in place of fixed ring 103 to create an attachment point for load binder 100. First hook 101 is utilized to couple the first end of load binder 100 to a fixed point securing a cargo or load. Fixed ring 103 is attached to outer housing 108 of load binder 100. Second hook 114 is coupled to another link 102 which is further coupled to fixed eye 111 located at a second end of load binder 100. Fixed eye 111 is coupled to inner housing 110 of load binder 100. Inner housing 110 has a threaded internal surface 117 that couples with threads 115 of lead screw 104. Screw head 116 is a hexagonal shape and is designed to couple with a complementary sized/shaped socket attached to a power drill (not shown).

In some embodiments of the present invention, link 102 may be a link that is welded closed. Other types of links 102 may be used, including those that may be connected and disconnected using removable pins or other means to open, close and secure link 102.

When screw head 116 is rotated in a first direction, the threads 115 on lead screw 104 are rotated in the threaded internal surface 117 of inner housing 110. In the first direction, the rotation of the complementary threads draws inner housing 110 closer to fixed ring 103, which in turn draws fixed eye 111 closer to fixed ring 103. This results in first hook 101 being drawn closer to second hook 114, resulting in additional tension on load binder 100. This tension assists in securing cargo or loads held in place using load binder 100. Typically, the first direction is right or clockwise. When screw head 116 is rotated in a second direction (typically counter-clockwise or left), inner housing 110 moves farther away from fixed ring 103 thus reducing tension on between the first hook 101 and second hook 114 of load binder 100.

In some embodiments of the present invention, link 102 may be a link that is welded closed. Other types of links 102 may be used, including those that may be connected and disconnected using removable pins or other means to open, close and secure link 102.

In this view, inner washer 105 is shown located abutting the head of lead screw 104. Outer washer 106 is shown abutting the end of inner housing 110 and providing spacing between inner washer 105 and inner housing 110. Inner washer 105 and outer washer 106 further provide smooth surfaces that allow easy rotation and movement of lead screw 104 into the threaded inner surface 117 of inner housing 110. Further, threads 115 are seen coupled with threaded inner surface 117. Also included in this view is sealing ring 109 which is a gasket providing a seal between inner housing 110 and outer housing 108. Sealing ring 109 prevents dust and other contaminants from entering the space between the housings. It further seals in any lubricant that may be utilized to ease the operation of load binder 100. In the preferred embodiment, sealing ring 109 is a rubber O-ring well known in the art, but can be any type of ring useful for sealing two surfaces. Blocking piece 107 closes an opening in inner housing 110 that allows access to a pin that fits into the end of lead screw 104 to prevent lead screw 104 from separating completely from inner housing 110 while being rotated.

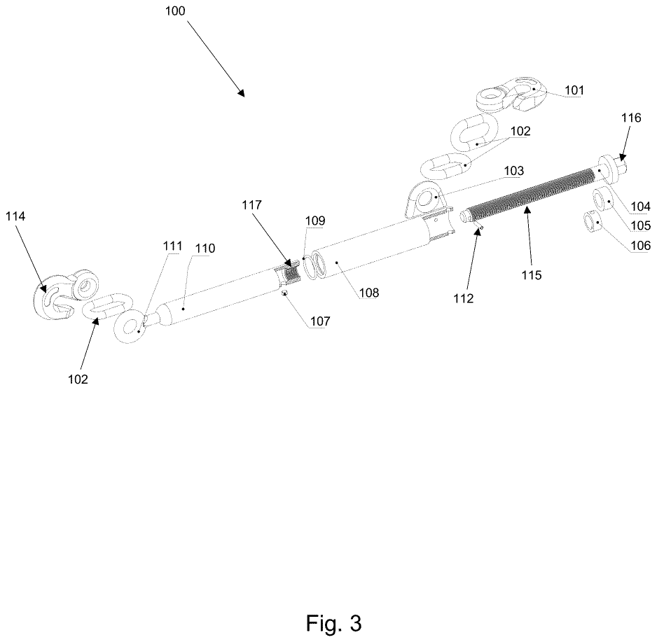

FIG. 3 displays an exploded view of improved drill powered load binder 100 of the present invention. First hook 101 is shown decoupled from link 102 which is further decoupled from fixed ring 103. Any configuration of hooks, links, rings or clevis yokes could be used in place of fixed ring 103 to create an attachment point for load binder 100. First hook 101 is utilized to couple the first end of load binder 100 to a fixed point securing a cargo or load. Fixed ring 103 is attached to outer housing 108 of load binder 100. Second hook 114 is shown decoupled from another link 102 which is further decoupled from fixed eye 111, located at a second end of load binder 100. Fixed eye 111 is coupled to inner housing 110 of load binder 100. Inner housing 110 has a threaded internal surface 117 that couples with threads 115 of lead screw 104. Screw head 116 is a hexagonal shape and is designed to couple with a complementary sized/shaped socket attached to a power drill (not shown).

When screw head 116 is rotated in a first direction, the threads 115 on lead screw 104 are rotated in the threaded internal surface 117 of inner housing 110. In the first direction, the rotation of the complementary threads draws inner housing 110 closer to fixed ring 103, which in turn draws fixed eye 111 closer to fixed ring 103. This results in first hook 101 being drawn closer to second hook 114, resulting in additional tension on load binder 100. This tension assists in securing cargo or loads held in place using load binder 100. Typically, the first direction is right or clockwise. When screw head 116 is rotated in a second direction (typically counter-clockwise or left), inner housing 110 moves farther away from fixed ring 103 thus reducing tension on between the first hook 101 and second hook 114 of load binder 100.

Inner washer 105 is shown removed from the head of lead screw 104. When installed, inner washer 105 provides spacing between inner housing 108 and lead screw 104. Further, inner washer 105 assists in providing low friction rotation of the lead screw 104. Outer washer 106 is shown removed from inner housing 110. Inner washer 106 provides spacing between inner washer 105 and inner housing 110. Inner washer 105 and outer washer 106 further provide smooth surfaces that allow easy rotation and movement of lead screw 104 into the threaded inner surface 117 of inner housing 110. Further, threads 115 are seen decoupled from threaded inner surface 117. Also included in this view is sealing ring 109 which is a gasket providing a seal between inner housing 110 and outer housing 108. Sealing ring 109 prevents dust and other contaminants from entering the space between the housings. It further seals in any lubricant that may be utilized to ease the operation of load binder 100. In the preferred embodiment, sealing ring 109 is a rubber O-ring well known in the art, but can be any type of ring useful for sealing two surfaces. Blocking piece 107 closes an opening in inner housing 110 that allows access to pin 112 that fits into the end of lead screw 104 to prevent lead screw 104 from separating completely from inner housing 110 while being rotated.

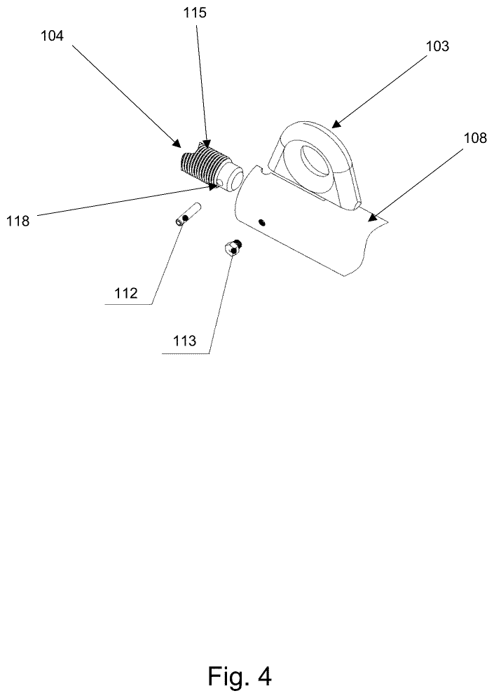

FIG. 4 shows a detailed view of pin 112 and oil nozzle 113 of the present invention. Pin 112 is inserted through pin slot 118 located at the end of lead screw 104. Pin 112 prevents lead screw 104 from being removed from outer housing 108 by contacting outer washer 106. Pin 112 is inserted in pin slot 118 through blocking piece 107 once lead screw 104 is installed in outer housing 108. When lead screw 104 is fully extended to the lowest tension position, i.e. when load binder 100 is fully extended, pin 112 will contact outer sleeve 106 and prevent lead screw 104 from extending further and being removed from outer housing 108.

Oil nozzle 113 allows lubricant to be inserted into outer housing 108 to lubricate threads 115 and threaded internal surface 117. This location also allows lubricant to contact inner washer 105 and outer washer 106 to further reduce friction between these surfaces for ease of rotation.

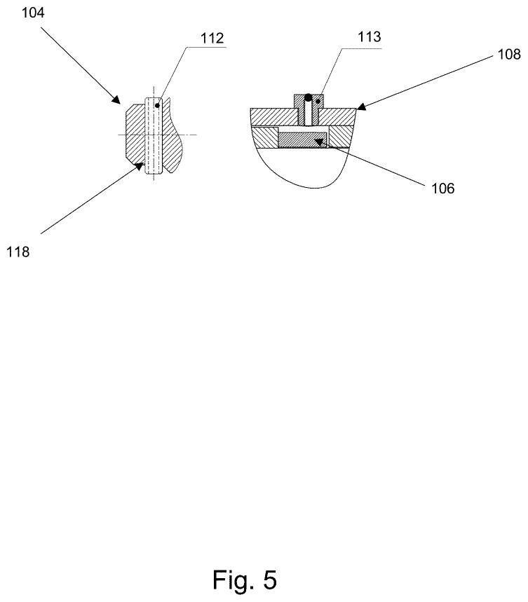

FIG. 5 shows a detailed view of pin 112 inserted in pin slot 118 at the end of lead screw 104. Pin 112 extends out from the edges of the base of lead screw 104 to prevent lead screw 104 from passing beyond outer washer 106 (not shown). A detailed view of oil nozzle 113 is also shown. Oil nozzle 113 passes through outer housing 108 to allow lubricant to be inserted on outer washer 106 and to further lubricate threads 115 and internal threaded surface 117.

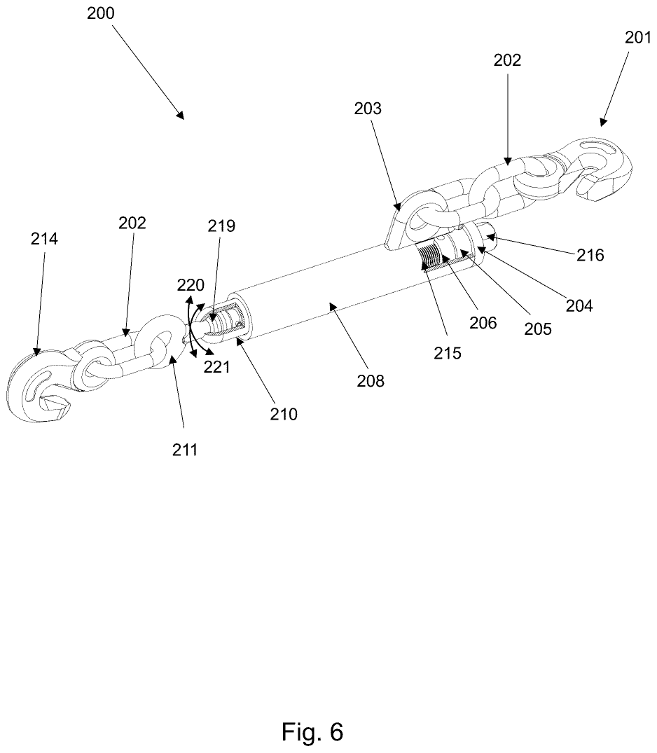

FIG. 6 is a perspective view of a second embodiment of the improved drill powered load binder 200 of the present invention. This embodiment of load binder 200 includes a swivel eye 211 that is fixed in inner housing 210 with a ball joint 219. Ball joint 219 allows swivel eye 211 to rotate 360 degrees or move laterally in two directional axes as shown by arrows 220 and 221. First hook 201 is shown coupled to two link(s) 202 which are coupled to fixed ring 203. Any configuration of hooks, links, rings or clevis yokes could be used in place of fixed ring 203 to create an attachment point for load binder 200. First hook 201 may be utilized to couple one end of load binder 200 with a fixed point to secure a cargo or load. Links 202 provide flexible coupling to fixed ring 203 which is attached to outer housing 208 of load binder 200. Links 202 may be of a closed/welded type or a removable type may be used, including those that may be connected and disconnected using removable pins or other means to open, close and secure link 202. Second hook 214 is coupled to another link 202 which is further coupled to swivel eye 211. Swivel eye 211 is coupled to inner housing 210 of load binder 200. Swivel eye 211 may rotate or move in two lateral directions as enabled by ball joint 219.

As in the first embodiment, Inner housing 210 has a threaded internal surface that couples with threads 215 of lead screw 204. Screw head 216 is a hexagonal shape in the preferred embodiment and is designed to couple with a complementary sized/shaped socket attached to a power drill (not shown). In the preferred embodiment, the shape of screw head 216 and complementary socket are hexagonal (six sided head), but any shape well known in the art may be used, such as square, eight point (eight sided), spline, 12 point, internal/external six point star shape (known as Torx®), internal hex, crowsfoot, other star configurations, or any other suitable shape.

When screw head 216 is rotated in a first direction, the threads 215 on lead screw 204 are rotated in the threaded internal surface of inner housing 210. In the first direction, the rotation of the complementary threads draws inner housing 210 closer to fixed ring 203, which in turn draws swivel eye 211 closer to fixed ring 203. This results in first hook 201 being drawn closer to second hook 214, resulting in additional tension on load binder 200. This tension assists in securing cargo or loads held in place using load binder 200. Typically, the first direction is right or clockwise. When screw head 216 is rotated in a second direction (typically counter-clockwise or left), inner housing 210 is moves farther away from fixed ring 203 thus reducing tension on between the first hook 201 and second hook 214 of load binder 200.

In this improved drill load binder 100, the rotation of screw head 216 may be performed with a powered drill (electrical or pneumatic) which results in significantly faster operation requiring minimal human labor, in contrast to prior art type load binder designs that must be tightened manually using a handle.

Improved drill powered load binder 200 is further comprised of inner washer 205 and outer washer 206 which provide spacing and separation between inner housing 208, outer housing 210 and lead screw 204.

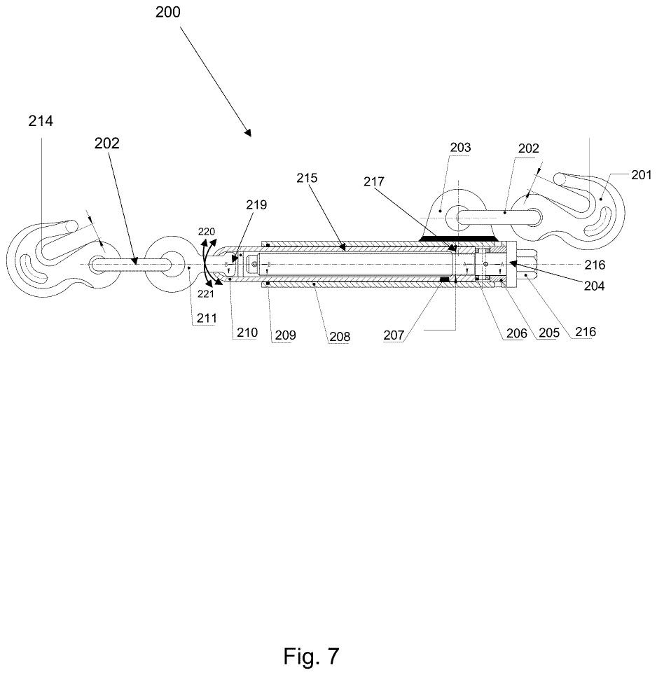

FIG. 7 displays a side view of improved drill powered load binder 200 of the present invention. First hook 201 is shown coupled to link 202 which is further coupled to fixed ring 203. Any configuration of hooks, links, rings or clevis yokes could be used in place of fixed ring 203 to create an attachment point for load binder 200. First hook 201 is utilized to couple the first end of load binder 200 to a fixed point securing a cargo or load. In this embodiment, swivel eye 211 is fixed in inner housing 210 with a ball joint 219. Ball joint 219 allows swivel eye 211 to rotate 360 degrees or move laterally in two directional axes as shown by arrows 220 and 221. Second hook 214 is coupled to another link 202 which is further coupled to swivel eye 211 located at a second end of load binder 200. Inner housing 210 has a threaded internal surface that couples with threads 215 of lead screw 204. Screw head 216 is a hexagonal shape and is designed to couple with a complementary sized/shaped socket attached to a power drill (not shown).

In some embodiments of the present invention, link 202 may be a link that is welded closed. Other types of links 202 may be used, including those that may be connected and disconnected using removable pins or other means to open, close and secure link 202.

When screw head 216 is rotated in a first direction, the threads 215 on lead screw 204 are rotated in the threaded internal surface 217 of inner housing 210. In the first direction, the rotation of the complementary threads draws inner housing 210 closer to fixed ring 203, which in turn draws fixed eye 211 closer to fixed ring 203. This results in first hook 201 being drawn closer to second hook 214, resulting in additional tension on load binder 200. This tension assists in securing cargo or loads held in place using load binder 200. Typically, the first direction is right or clockwise. When screw head 216 is rotated in a second direction (typically counter-clockwise or left), inner housing 210 is moves farther away from fixed ring 203 thus reducing tension on between the first hook 201 and second hook 214 of load binder 200.

Inner washer 205 is shown located abutting the head of lead screw 204. Outer washer 206 is shown abutting the end of inner housing 210 and providing spacing between inner washer 205 and inner housing 210. Inner washer 205 and outer washer 206 further provide smooth surfaces that allow easy rotation and movement of lead screw 204 into the threaded inner surface 217 of inner housing 210. Further, threads 215 are seen coupled with threaded inner surface 217. Also included in this view is sealing ring 209 which is a gasket providing a seal between inner housing 210 and outer housing 208. Sealing ring 209 prevents dust and other contaminants from entering the space between the housings. It further seals in any lubricant that may be utilized to ease the operation of load binder 200. In the preferred embodiment, sealing ring 209 is a rubber O-ring well known in the art, but can be any type of ring useful for sealing two surfaces. Blocking piece 207 closes an opening in inner housing 210 that allows access to a pin that fits into the end of lead screw 204 to prevent lead screw 204 from separating completely from inner housing 210 while being rotated.

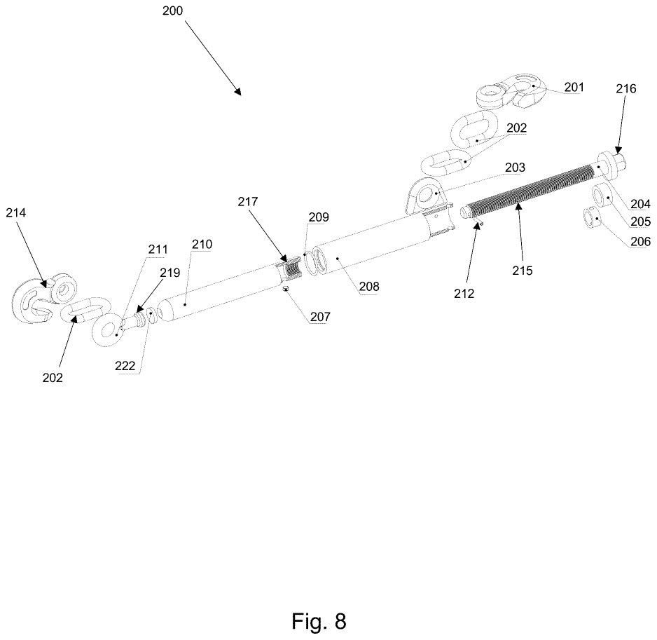

FIG. 8 displays an exploded view of the second embodiment of the improved drill powered load binder 200. First hook 201 is shown decoupled from link 202 which is further decoupled from fixed ring 203. Any configuration of hooks, links, rings or clevis yokes could be used in place of fixed ring 203 to create an attachment point for load binder 200. First hook 201 is utilized to couple the first end of load binder 200 to a fixed point securing a cargo or load. Links 202 provide flexible coupling to fixed ring 203 which is attached to outer housing 208 of load binder 200. Links 202 may be of a closed/welded type or a removable type may be used, including those that may be connected and disconnected using removable pins or other means to open, close and secure link 202. Second hook 214 is shown decoupled from another link 202 which is further decoupled from swivel eye 211, located at a second end of load binder 200. In this embodiment, swivel eye 211 is fixed in inner housing 210 with a ball joint 219. Ball joint 219 allows swivel eye 211 to rotate 360 degrees or move laterally in two directional axes. Inner housing 210 has a threaded internal surface 217 that couples with threads 215 of lead screw 204. Screw head 216 is a hexagonal shape and is designed to couple with a complementary sized/shaped socket attached to a power drill (not shown).

When screw head 216 is rotated in a first direction, the threads 215 on lead screw 204 are rotated in the threaded internal surface 217 of inner housing 210. In the first direction, the rotation of the complementary threads draws inner housing 210 closer to fixed ring 203, which in turn draws swivel eye 211 closer to fixed ring 203. This results in first hook 201 being drawn closer to second hook 214, resulting in additional tension on load binder 100. This tension assists in securing cargo or loads held in place using load binder 200. Typically, the first direction is right or clockwise. When screw head 216 is rotated in a second direction (typically counter-clockwise or left), inner housing 210 is moves farther away from fixed ring 203 thus reducing tension on between the first hook 201 and second hook 214 of load binder 200.

Inner washer 205 is shown removed from the head of lead screw 204. When installed, inner washer provides spacing between inner housing 208 and lead screw 204. Further, inner washer 205 assists in providing low friction rotation of the lead screw 204. Outer washer 206 is shown removed from inner housing 210. Inner washer 206 provides spacing between inner washer 205 and inner housing 210. Inner washer 205 and outer washer 206 further provide smooth surfaces that allow easy rotation and movement of lead screw 204 into the threaded inner surface 217 of inner housing 210. Further, threads 215 are seen decoupled from threaded inner surface 217. Also included in this view is sealing ring 209 which is a gasket providing a seal between inner housing 210 and outer housing 208. Sealing ring 209 prevents dust and other contaminants from entering the space between the housings. It further seals in any lubricant that may be utilized to ease the operation of load binder 200. In the preferred embodiment, sealing ring 209 is a rubber O-ring well known in the art, but can be any type of ring useful for sealing two surfaces. Blocking piece 207 closes an opening in inner housing 210 that allows access to pin 212 that fits into the end of lead screw 204 to prevent lead screw 204 from separating completely from inner housing 210 while being rotated. Weld blocking plate 222 is welded inside the inner housing 210 in a location that creates an enclosed space allowing free movement of ball joint 219 but preventing dust, dirt and debris from entering the inner housing 210.

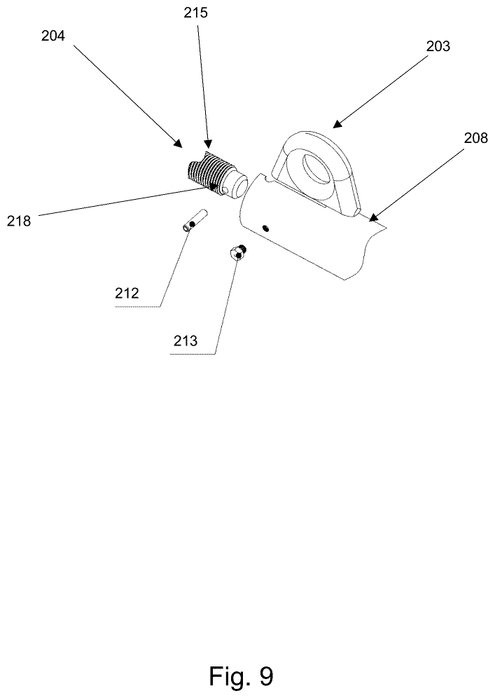

FIG. 9 shows a detailed view of pin 212 and oil nozzle 213 of the present invention. Pin 212 is inserted through pin slot 218 located at the end of lead screw 204. Pin 212 prevents lead screw 204 from being removed from outer housing 208 by contacting outer washer 206. Pin 212 is inserted in pin slot 218 through blocking piece 207 once lead screw 204 is installed in outer housing 208. When lead screw 204 is fully extended to the lowest tension position, i.e. when load binder 200 is fully extended, pin 212 will contact outer sleeve 206 and prevent lead screw 204 from extending further and being removed from outer housing 208.

Oil nozzle 213 allows lubricant to be inserted into outer housing 208 to lubricate threads 215 and threaded internal surface 217. This location also allows lubricant to contact inner sleeve 205 and outer sleeve 206 to further reduce friction between these surfaces for ease of rotation.

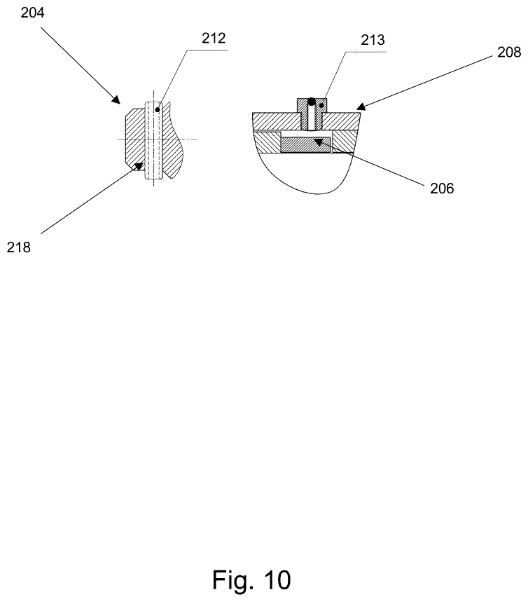

FIG. 10 shows a detailed view of pin 212 inserted in pin slot 218 at the end of lead screw 204. Pin 212 extends out from the edges of the base of lead screw 204 to prevent lead screw 204 from passing beyond outer washer 206 (not shown). A detailed view of oil nozzle 213 is also shown. Oil nozzle 213 passes through outer housing 208 to allow lubricant to be inserted on outer washer 206 and to further lubricate threads 215 and internal threaded surface 217.

In the preferred embodiment, load binder 100 and load binder 200 are manufactured from forged steel. A variety of suitable high strength metal materials may also be used such as aluminum, stainless steel, iron, titanium, tungsten, or any other material well known in the art and suitable for the disclosed operation. Load binder 100/200 may be manufactured using any process well known in the art and suitable for high strength metals. Such processes include forging, casting, cutting, molding, extruding, forming, or CNC machining and lathing. Furthermore, any finished part may be subject to various heat treatment processes and surface finishes.

Although the present invention has been described in relation to the above disclosed preferred embodiment, many modifications in design, implementation, systems and execution are possible while still maintaining the novel features and advantages of the invention. The preferred embodiment is not meant to limit the scope of the patent in any way, and it should be given the broadest possible interpretation consistent with the language of the disclosure on the whole.

1. A drill powered load binder comprising:
an outer housing with an outer housing cavity and a first attachment point coupled to the outer housing;
an inner housing with an inner housing cavity and a second attachment point coupled to a first end of an inner housing, where the inner housing is sized to fit within the outer housing cavity and an interior wall of the inner housing cavity further comprises inner housing cavity threads, and where the inner housing is fit within the outer housing cavity;
a lead screw comprising a head at a first end and a threaded shaft comprising lead screw threads that are sized to couple with the inner housing cavity threads, where the lead screw is fit through the outer housing and the inner housing and coupled with the inner housing cavity threads; and
where when the head of the lead screw is rotated in a first direction, the inner housing travels in a first direction in relation to the outer housing, and when the head of the lead screw is rotated in a second direction, the inner housing travels in a second direction in relation to the outer housing.

2. The drill powered load binder of claim 1 where the first attachment point comprises a first ring and the second attachment point comprises a second ring.

3. The drill powered load binder of claim 2 further comprising a first hook coupled to the first attachment ring and a second hook coupled to the second attachment ring.

4. The drill powered load binder of claim 3 further comprising at least one link coupled between the first hook and the first attachment ring and at least one link coupled between the second hook and second attachment ring.

5. The drill powered load binder of claim 1 further comprising an inner washer and an outer washer fit over the lead screw and located between the head of the lead screw and a second end of the inner housing.

6. The drill powered load binder of claim 5 where the lead screw further comprises a pin slot at a second end for locating a pin, an opening in the inner housing, a blocking piece sized to fit in the opening in the inner housing, where the pin is fit in the pin slot through the opening in the inner housing, where the pin contacts the outer washer to prevent the lead screw from exiting the inner housing and where the blocking piece overs the opening in the inner housing.

7. The drill powered load binder of claim 1 further comprising a sealing ring fit between the inner housing and the outer housing.

8. The drill powered load binder of claim 1 further comprising an oil nozzle in the outer housing.

9. The drill powered load binder of claim 1 where a shape of the head of the lead screw is selected from the group consisting of hexagonal, six sided, square, eight point, eight sided, spline, 12 point, internal six point star shape, external six point star shape, internal Torx®, external Torx®, internal hex, and crowsfoot.

10. A drill powered load binder comprising:
an outer housing with an outer housing cavity and a first attachment point coupled to the outer housing;
an inner housing with an inner housing cavity and a second attachment point coupled to a ball joint at a first end of an inner housing, where the inner housing is sized to fit within the outer housing cavity and an interior wall of the inner housing cavity further comprises inner housing cavity threads, and where the inner housing is fit within the outer housing cavity;
a lead screw comprising a head at a first end and a threaded shaft comprising lead screw threads that are sized to couple with the inner housing cavity threads, where the lead screw is fit through the outer housing and the inner housing and coupled with the inner housing cavity threads; and
where when the head of the lead screw is rotated in a first direction, the inner housing travels in a first direction in relation to the outer housing, and when the head of the lead screw is rotated in a second direction, the inner housing travels in a second direction in relation to the outer housing.

11. The drill powered load binder of claim 10 where the first attachment point comprises a first ring and the second attachment point comprises a second ring.

12. The drill powered load binder of claim 11 further comprising a first hook coupled to the first attachment ring and a second hook coupled to the second attachment ring.

13. The drill powered load binder of claim 12 further comprising at least one link coupled between the first hook and the first attachment ring and at least one link coupled between the second hook and second attachment ring.

14. The drill powered load binder of claim 10 further comprising an inner washer and an outer washer fit over the lead screw and located between the head of the lead screw and a second end of the inner housing.

15. The drill powered load binder of claim 14 where the lead screw further comprises a pin slot at a second end for locating a pin, an opening in the inner housing, a blocking piece sized to fit in the opening in the inner housing, where the pin is fit in the pin slot through the opening in the inner housing, where the pin contacts the outer washer to prevent the lead screw from exiting the inner housing and where the blocking piece overs the opening in the inner housing.

16. The drill powered load binder of claim 10 further comprising a sealing ring fit between the inner housing and the outer housing.

17. The drill powered load binder of claim 10 further comprising an oil nozzle in the outer housing.

18. The drill powered load binder of claim 10 where a shape of the head of the lead screw is selected from the group consisting of hexagonal, six sided, square, eight point, eight sided, spline, 12 point, internal six point star shape, external six point star shape, internal Torx®, external Torx®, internal hex, and crowsfoot.
